(19) United States
(12) Patent Application Publication
(10) Pub. No.: US 2007/0111594 A1
(43) Pub. Date: May 17, 2007

(54) CLIP ASSEMBLY

(75) Inventor: Chih Chun Huang, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: AMA PRECISION INC., Taipei City (TW)

(21) Appl. No.: 11/538,065

(22) Filed: Oct. 3, 2006

(30) Foreign Application Priority Data
Nov. 11, 2005 (TW) 94139582

(51) Int. Cl. H01R 13/73

(52) U.S. Cl. 439/553

(57) ABSTRACT

A clip assembly for clipping a heatsink module on the first or second circuit board is provided. The first and second circuit boards respectively have first and second mounting holes located around the first and second device. The clip assembly includes a base, mounting parts and a clipper. The base located on the first or second circuit board has an opening, first clipping portions, third and fourth mounting holes. The first or second device is disposed in the opening and the heatsink module is in contact with the first or second device. The mounting parts pass through the corresponding first and third mounting holes or through the corresponding second and fourth mounting holes for fixing the base on the first or second circuit board. The clipper has second clipping portions to clasp first clipping portions so as to clip the heatsink module on the base.

### CROSS-REFERENCE TO RELATED APPLICATION

This application claims the priority benefit of Taiwan application serial no. 94139582, filed on Nov. 11, 2005. All disclosure of the Taiwan application is incorporated herein by reference.

### BACKGROUND OF THE INVENTION

1. Field of Invention

The present invention relates to a clip assembly. More particularly, the present invention relates to a clip assembly for clipping a heatsink module on a circuit board.

2. Description of Related Art

The integrated circuit (IC) has been widely applied in chips of electronic products such as personal computers, laptops and servers along with the improvement of the semiconductor technology. However, as the process speed and functions increase continuously, the heat generated from the ICs also raise correspondingly. If the heat can not be effectively dissipated, it is likely that the electronic device will be out of function because of the heat. Therefore, different kinds of heat dissipation methods for immediately dissipating the heat have been proposed so as to avoid the malfunction of electronic devices.

For the electronic devices installed on the circuit board such as the central processing unit (CPU), the video chip, or the audio chip, etc., the method of heat dissipation usually uses a clip assembly to clip a heatsink module on the circuit board, so that the heatsink is in contact with the electronic device to provide assistance for dissipating heat out of the electronic device. The clip assembly has the heatsink module attached to the electronic device closely by a suitable downward pressure.

Generally, in the market, the specifications of the electronic devices (such as CPU) provided by different companies are usually different, so that the circuit boards (or platforms) used to cooperate with the electronic devices are also different. Therefore, in order to provide a clip assembly suitable for circuit boards of different specifications for customers, the conventional clip assembly must comprise a plurality of accessories with same function but different specifications. For example, the clip assembly may comprise two bases of different specifications, so as to be assembled on two different circuit boards. Accordingly, the conventional clip assembly has a lot of accessories and some of which are superfluous, which does not tally with the consideration of cost saving.

### SUMMARY OF THE INVENTION

Accordingly, the present invention is directed to provide a clip assembly to resolve the problem of superfluous accessories in the conventional clip assembly. The clip assembly of the present invention is suitable for more than two different circuit boards, so that the quantity of the accessories can be reduces and thus the cost is lowered.

The present invention provides a clip assembly for clipping a heatsink module on a first or a second circuit board. A first device is disposed on the first circuit board and a second device is disposed on the second circuit board. Wherein, the first circuit board has a plurality of first mounting holes located around the first device, and the second circuit board has a plurality of second mounting holes located around the second device. The clip assembly includes a base, a plurality of mounting parts and a clipper. The base located on the first or second circuit board has an opening, a plurality of first clipping portions, and a plurality of third and fourth mounting holes. The first or second device is disposed in the opening, and at least one part of the heatsink module is in contact with the first or second device. The locations of the third mounting holes correspond to the locations of the first mounting holes, and the locations of the fourth mounting holes correspond to the locations of the second mounting holes. Moreover, the mounting parts pass through the first and third mounting holes or the second and fourth mounting holes for fixing the base on the first or second circuit board. The clipper has a plurality of second clipping portions to clasp the first clipping portions so as to clip the heatsink module on the base.

According to one embodiment of the present invention, the clip assembly is further suitable to clip the heatsink module on a third circuit board, so that the heatsink module is in contact with a third device on the third circuit board. Wherein, the third circuit board has a plurality of fifth mounting holes located around the third device, and the base further has a plurality of sixth mounting holes corresponding to the locations of the fifth mounting holes.

According to one embodiment of the present invention, the clip assembly may further include a back board, fixed on the back surface of the first or the second circuit board, and a plurality of seventh mounting holes and a plurality of eighth mounting holes are disposed on the back board. The locations of the seventh mounting holes correspond to the locations of the first mounting holes and the locations of the third mounting holes, and the locations of the eighth mounting holes correspond to the locations of the second mounting holes and the fourth mounting holes.

According to one embodiment of the present invention, the clip assembly further includes a plurality of pedestal pillars, disposed between the base and the first or the second circuit board, and the mounting parts pass through the pedestal pillars.

According to one embodiment of the present invention, the mounting parts may be screws or bolts.

According to one embodiment of the present invention, a first distance of the first mounting holes is greater than a second distance of the second mounting holes.

According to one embodiment of the present invention, the first clipping portions are, for example, a clasp curved inward from at least one edge of the base, and the second clipping portions are, for example, a clipping hole.

According to one embodiment of the present invention, the first clipping portions are, for example, a clasp curved outward from at least one edge of the base, and the second clipping portions are, for example, a clipping hole.

According to one embodiment of the present invention, the clipper further includes a clipping pole. And, the clipper is suitable to be released when the clipping pole is disposed at a first position, and the clipper is suitable to be clipped steadily on the base when the clipping pole is switched to a second position.

As the clip assembly of the present invention utilizes the base having a plurality of groups of mounting holes, the clip assembly can be used to clip the heatsink on different kinds of circuit boards. Therefore, the quantity of the accessories included in the clip assembly can be reduced; accordingly, the cost can be lowered.

In order to the make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an explode view of a clip assembly for clipping heatsink on the first circuit board according to one embodiment of the present invention.

FIG. 2 is an assemble perspective view of the clip assembly, the heatsink module, and the first circuit board in FIG. 1.

FIG. 3A is the second circuit board and the second device disposed on the second circuit board.

FIG. 3B is the perspective view showing that the clip assembly and the heatsink module in FIG. 1 are assembled onto the second circuit board.

FIG. 4A is the third circuit board and the third device disposed on the third circuit board.

FIG. 4B is the perspective view showing that the clip assembly and the heatsink module of the present embodiment are assembled onto the third circuit board.

FIG. 5A and FIG. 5B demonstrate the operation of the clipper in FIG. 1.

FIG. 6 is the bottom view showing that the back board of the present embodiment is mounted on the back side of the back board of the first circuit board.

### DESCRIPTION OF EMBODIMENTS

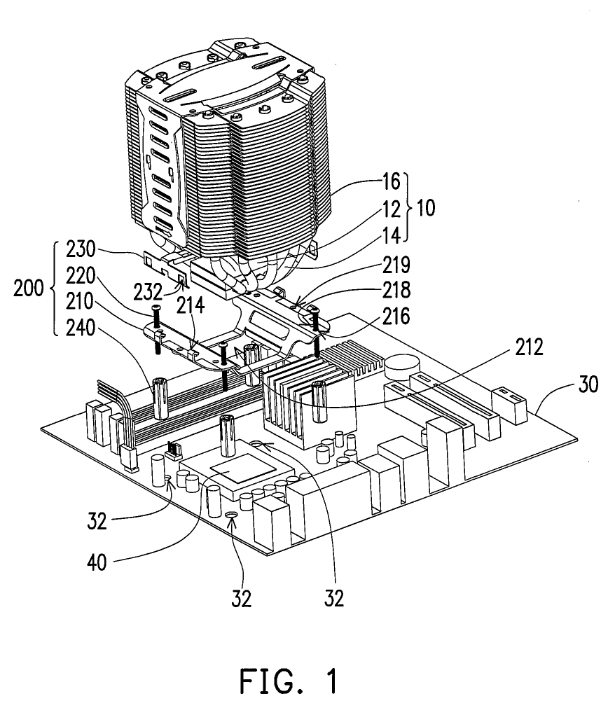

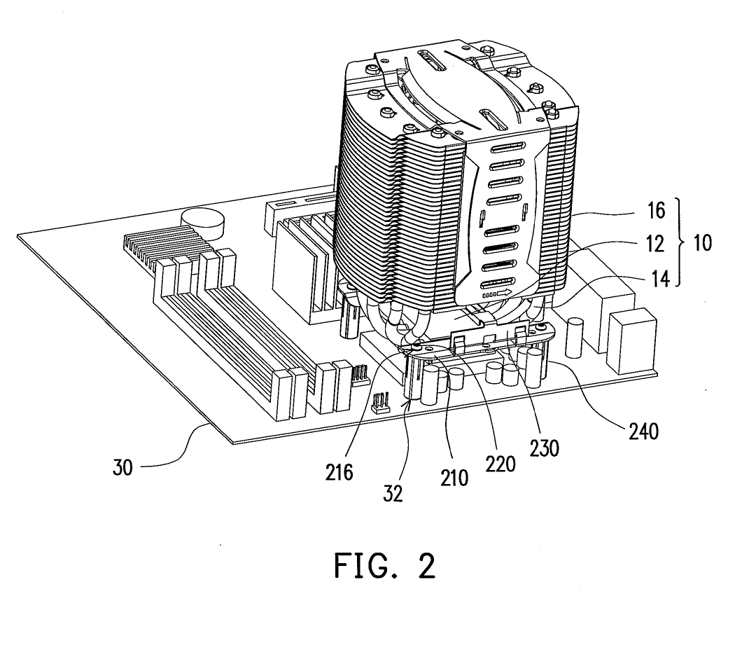

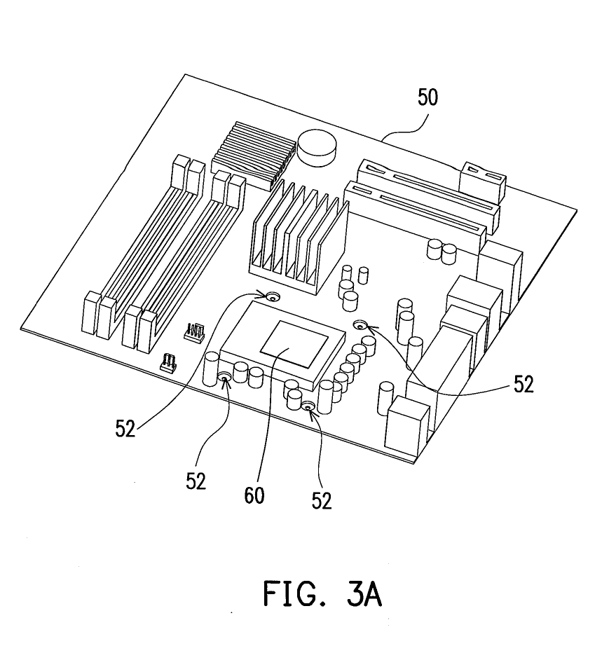

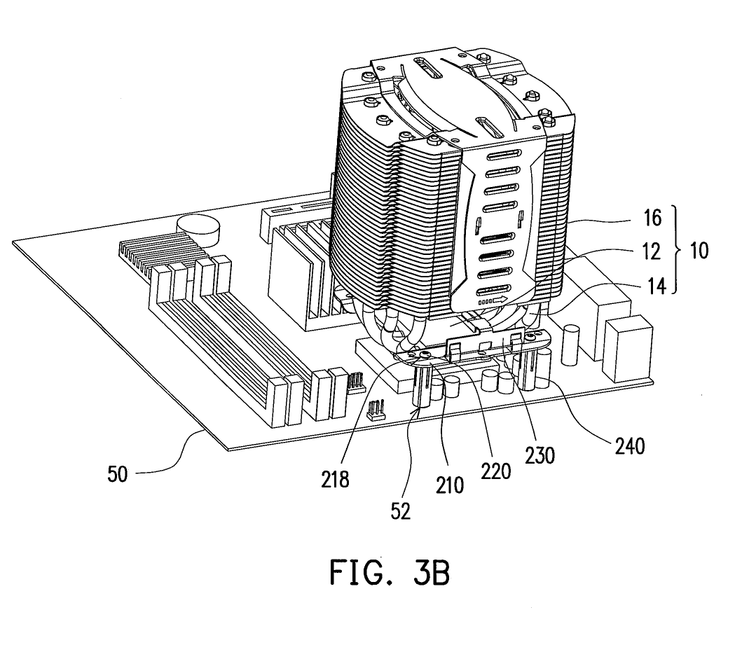

FIG. 1 is an explode view of a clip assembly for clipping heatsink on the first circuit board according to one embodiment of the present invention, and FIG. 2 is an assemble perspective view of the clip assembly, the heatsink module, and the first circuit board in FIG. 1. FIG. 3A is the second circuit board and the second device disposed on the second circuit board, and FIG. 3B is the perspective view showing that the clip assembly and the heatsink module in FIG. 1 are assembled onto the second circuit board in FIG. 3A.

Referring to FIG. 1, FIG. 2, FIG. 3A, and FIG. 3B, the clip assembly 200 of the embodiment is suitable to clip a heatsink module 10 on a first circuit board 30 (as shown in FIG. 2) or a second circuit board 50 (as shown in FIG. 3B). The heatsink module 10 includes a bottom block 12, a plurality of heat pipes 14 and a plurality of radiation fins 16. The heat pipes 14 are connected between the bottom block 12 and the radiation fins 16, and the heat pipes 14 are connected with the radiation fins 16 in series. As shown in FIG. 1, a first device 40 is disposed on the first circuit board 30, and the first circuit board 30 has a plurality of first mounting holes 32 located around the first device 40. As shown in FIG. 3A, a second device 60 is disposed on the second circuit board 50, and the second circuit board 50 has a plurality of second mounting holes 52 located around the second device 60. Wherein, the distance between the first mounting holes 32 is, for example, greater than the distance between the second mounting holes 52. For example, the first device 40 and the second device 60, for example, are respectively the central processing unit (CPU) made by Intel Corporation and the CPU made by AMD, Inc., and the first circuit board 30 and the second circuit board 50 are the motherboards (or called platforms) respectively suitable for mounting the first device 40 and the second device 60.

The clip assembly 200 includes a base 210, a plurality of mounting parts 220 and a clipper 230. The base 210 has an opening 212, a plurality of first clipping portions 214, a plurality of third mounting holes 216 and a plurality of fourth mounting holes 218. The base 210 is suitable to be installed on the first circuit board 30 or the second circuit board 50. When the base 210 is installed on the first circuit board 30, the first device 40 is disposed in the opening 212 of the base 210. When the base 210 is installed on the second circuit board 50, the second device 60 is disposed in the opening 212 of the base 210. In addition, at least one part of the heatsink module 10 is in contact with the first device 40 or the second device 60. Moreover, the locations of the third mounting holes 216 of the base 210 correspond to the locations of the first mounting holes 32, and the locations of the fourth mounting holes 218 of the base 210 correspond to the locations of the second mounting holes 52.

Referring to FIG. 2, FIG. 3A and FIG. 3B, the mounting parts 220 of the clip assembly 200 fixes the base 210 on the first circuit board 30 or the second circuit board 50 by passing through the first mounting holes 32 and the third mounting holes 216, or passing through the second mounting holes 52 and the fourth mounting holes 218. The mounting parts 220 may be screws or bolts. In addition, as shown in FIG. 2 and FIG. 3B, the clip assembly 200 may further include a plurality of pedestal pillars 240, disposed between the base 210 and the first circuit board 30 or the second circuit board 50, and the mounting parts 220 pass through the pedestal pillars 240. The pedestal pillars 240 can keep a predefined height between the base 210 and the first circuit board 30 or the second circuit board 50, so that other electronic parts such as capacitors, inductances can be mounted on the first circuit board 30 or the second circuit board 50 under the side of the base 210.

It can be learned from the above that, the base 210 of the clip assembly 200 of the present invention has a plurality of third mounting holes 216 and as well as a plurality of fourth mounting holes 218, and the locations of the third and fourth mounting holes 216, 218 respectively correspond to the locations of the first and the second mounting holes 32, 52. Accordingly, the clip assembly 200 can be installed on the first circuit board 30 or the second circuit board 50. That is, as the base 210 of the clip assembly 200 of the present invention has the mounting holes suitable for different circuit boards, the fewer accessories can cover the specification requirements of different circuit boards compared to the conventional technology, so that no superfluous parts are needed, and further, the cost is reduced.

Referring to FIG. 1, the base 210 has a plurality of first clipping portions 214, and the clipper 230 has a plurality of second clipping portions 232. Wherein, the second clipping portions 232 is used to clasp the first clipping portions 214 so as to clip the heatsink module 10 on the base 210. In the embodiment, the first clipping portions 214, for example, are a clasp curved inward from at least one edge of the base 210, and the second clipping portions 232 are, for example, a clipping hole. Accordingly, the first clipping portion 214 can clasp the second clipping portion 232 so as to clip the heatsink module 10 on the base 210. According to the present invention, the first clipping portions 214 are a clasp curved outward from at least one edge of the base 210, and the second clipping portions 232 may be a clipping hole.

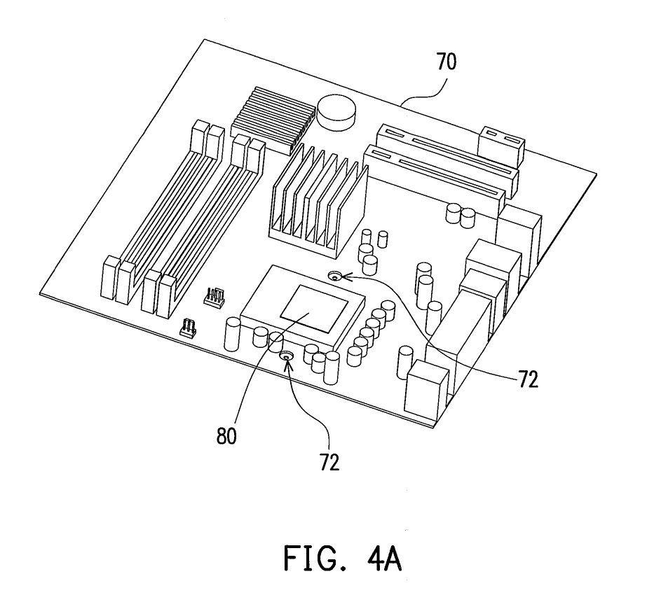

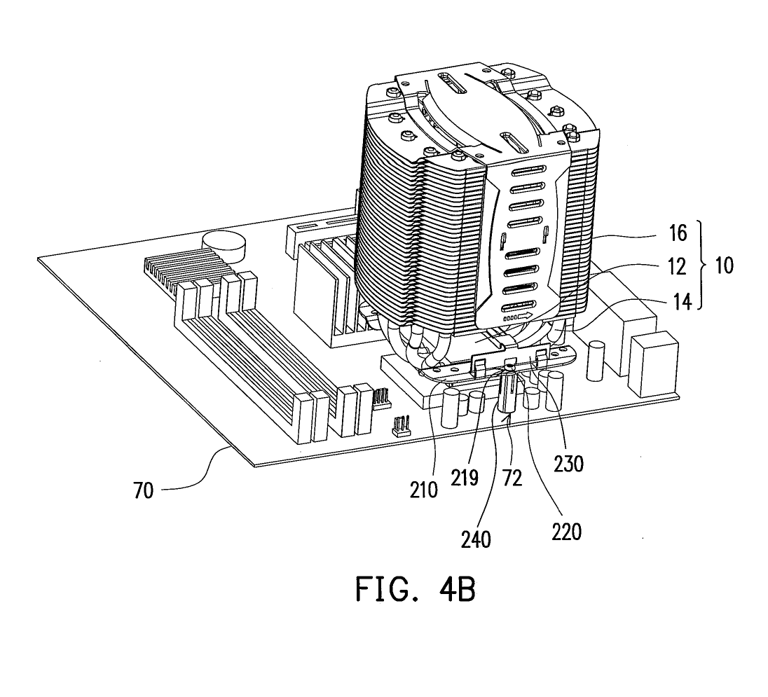

Referring to FIG. 4A and FIG. 4B, FIG. 4A is the third circuit board and the third device disposed on the third circuit board, and FIG. 4B is the perspective view showing that the clip assembly and the heatsink module of FIG. 1 are assembled onto the third circuit board in FIG. 4A. Referring to FIG. 4A, a third device 80 is disposed on the third circuit board 70. The third circuit board 70 has a plurality of fifth mounting holes 72 located around the third device 80, and the base 210 further includes a plurality of sixth mounting holes 219. Moreover, the location of the sixth mounting holes 219 of the base 210 correspond to the location of the fifth mounting holes 72. Therefore, the clip assembly 200 of the present invention is more suitable to clip the heatsink module 10 on the third circuit board 70 (as shown in FIG. 4B). When the base 210 is mounted on the third circuit board 70, the third device 80 is disposed in the opening 212 of the base 210. Moreover, at least one part of the heatsink module 10 is in contact with the third device 80.

Referring to FIG. 4B, the mounting parts 220 of the clip assembly 200 fix the base 210 on the third circuit board 70 by passing through the fifth mounting holes 72 and the sixth mounting holes 219. In addition, as shown in FIG. 4B, the pedestal pillars 240 of the clip assembly 200 can be disposed between the base 210 and the third circuit board 70, and the mounting parts 200 pass through the pedestal pillars 240. As described above, the pedestal pillars 240 can keep a predefined height between the base 210 and the third circuit board 70, so that other electronic parts such as capacitors, inductances can be disposed on the third circuit board 70 under the side of the base 210.

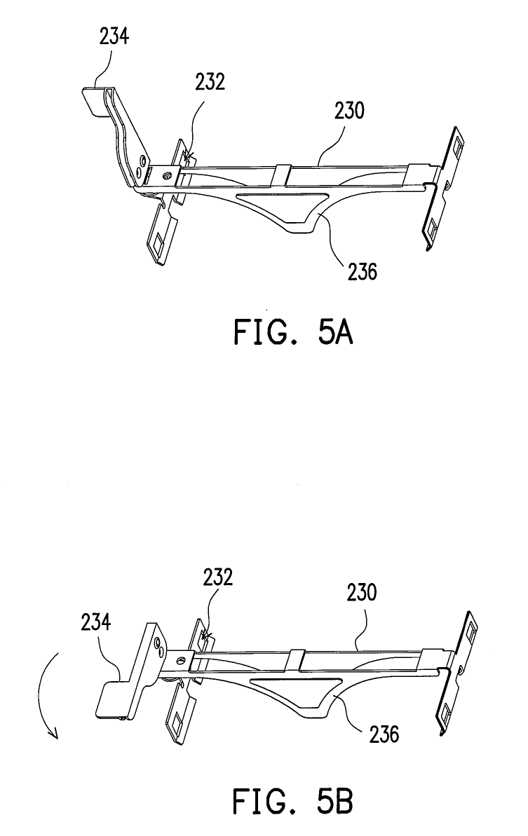

FIG. 5A and FIG. 5B demonstrate the operation of the clipper in FIG. 1. Referring to FIG. 1, FIG. 5A and FIG. 5B, the clipper 230, for example, has a clipping pole 234. The clipping pole 234 clips the first clipping portion 214 into the second clipping portion 232 of the clipper 230 steadily by a downward pressure, and clips the heatsink module 10 steadily on the first circuit board 30 (as shown in FIG. 2), the second circuit board 50 (as shown in FIG. 3B), or the third circuit board 70 (as shown in FIG. 4B). In FIG. 5A, the clipping pole 234 is disposed at the first position and the clipper 230 can be released from the base 210. In FIG. 5B, the clipping pole 234 is rotated (as shown by the arrow) and pressed downward to a second position by force, and the clipper 230 can be clipped steadily on the base 210.

It needs to be noted that a thin board 236 extending downward at the center of the clipper 230 is provided for supporting the heatsink module 10. The thin board 236 helps the bottom block 12 of the heatsink module 10 to be in contact with the first, the second, or the third electronic device 40, 60, 80 (as shown in FIG. 2, FIG. 3B and FIG. 4B, respectively).

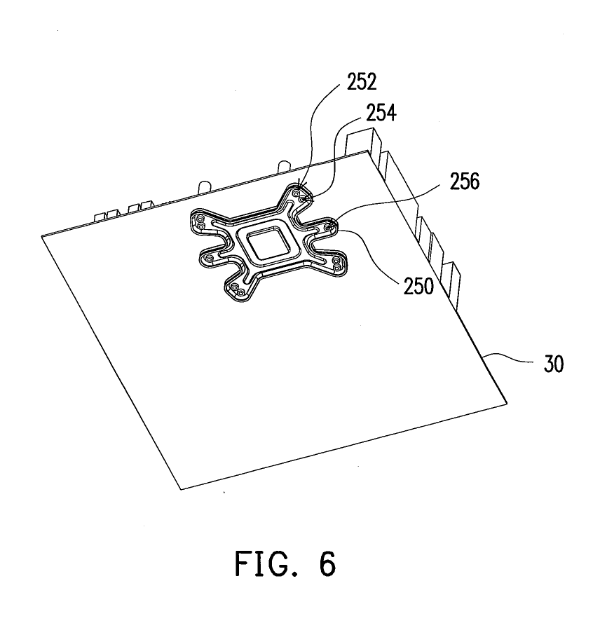

In addition, the clip assembly 200 further includes a back board 250. The back board 250 can enhance the clipping strength (i.e., the clipping pressure provided by the clip assembly 200) between the heatsink module 10 and the first or second circuit board 30, 50; and the bending moment on the first or second circuit board 30, 50 (or the third circuit board 70) resulting from the side pressure due to the weight can be avoided. Referring to FIG. 6, FIG. 6 is the bottom view showing that the back board of the present embodiment is mounted on the back side of the back surface of the first circuit board. The back board 250 can be mounted on the back surface of the first circuit board 30 or mounted on the back surface of the second circuit board 50, and has a plurality of seventh mounting holes 252 and a plurality of eighth mounting holes 254. The seventh mounting holes 252 correspond to the first mounting hole 32 and the third mounting holes 216, and the eighth mounting holes 254 correspond to the second mounting holes 52 and the fourth mounting holes 218. Therefore, the back board 250 can be fixed on the back surface of the first circuit board 30 by the mounting parts 220 passing through the first mounting holes 32, the third mounting holes 216 and the seventh mounting holes 252. Also, the back board 250 can be fixed on the back surface of the second circuit board 50 by the mounting parts 220 passing through the second mounting holes 52, the fourth mounting holes 218 and the eighth mounting holes 254. Of course, the back board 250 can have a plurality of ninth mounting holes 256, and the back board 250 can be fixed on the back surface of the third circuit board 70 by the mounting parts 220 passing through the fifth mounting holes 72, the sixth mounting holes 219 and the ninth mounting holes 256.

In summary, as the clip assembly of the present invention applies the base having a plurality of groups of mounting holes of different specifications, the clip assembly is suitable to clip the heatsink module on different circuit boards. Therefore, the quantity of the accessories included in the clip assembly can be reduced and the cost is saved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A clip assembly, suitable for clipping a heatsink module on a first or a second circuit board, and, a first device is disposed on the first circuit board and a second device is disposed on the second circuit bard, wherein, the first circuit board has a plurality of first mounting holes located around the first device, and the second circuit board has a plurality of second mounting holes located around the second device, and the clip assembly includes:
a base, located on the first or second circuit board, and the base has an opening, wherein the first or second device is disposed in the opening and at least one part of the heatsink module is in contact with the first or second device, and the base has a plurality of first clipping portions, a plurality of third and fourth mounting holes, wherein the locations of the third mounting holes correspond to the locations of the first mounting holes, and the locations of the fourth mounting holes correspond to the locations of the second mounting holes;
a plurality of mounting parts, passing through the first and third mounting holes or the second and fourth mounting holes for fixing the base on the first or second circuit board; and
a clipper, having a plurality of second clipping portions to clasp the first clipping portions so as to clip the heatsink module on the base.

2. The clip assembly as claimed in claim 1, is further suitable to clip the heatsink module on a third circuit board, so that the heatsink module is in contact with a third device on the third circuit board, wherein, the third circuit board has a plurality of fifth mounting holes located around the third device, and the base further has a plurality of sixth mounting holes corresponding to the locations of the fifth mounting holes.

3. The clip assembly as claimed in claim 1, further includes a back board, fixed on the back surface of the first or the second circuit board, and a plurality of seventh mounting holes and a plurality of eighth mounting holes are disposed on the back board, wherein the locations of the seventh mounting holes correspond to the locations of the first mounting holes and the third mounting holes, and the locations of the eighth mounting holes correspond to the locations of the second mounting holes and the fourth mounting holes.

4. The clip assembly as claimed in claim 1 further includes a plurality of pedestal pillars, disposed between the base and the first or the second circuit board, and the mounting parts pass through the pedestal pillars.

5. The clip assembly as claimed in claim 1, wherein the mounting parts are screws or bolts.

6. The clip assembly as claimed in claim 1, wherein a first distance of the first mounting holes is greater than a second distance of the second mounting holes.

7. The clip assembly as claimed in claim 1, wherein the first clipping portions include a clasp curved inward from at least one edge of the base, and the second clipping portions include a clipping hole.

8. The clip assembly as claimed in claim 1, wherein the first clipping portions include a clasp curved outward from at least one edge of the base, and the second clipping portions include a clipping hole.

9. The clip assembly as claimed in claim 1, wherein the clipper further includes a clipping pole, the clipper is suitable to be released when the clipping pole is disposed at a first position, and the clipper is suitable to be clipped steadily on the base when the clipping pole is switched to a second position.
